(19) United States
(12) Patent Application Publication
(10) Pub. No.: US 2013/0315678 A1
(43) Pub. Date: Nov. 28, 2013

(54) RETAINING WALL BLOCK

(71) Applicant: William H. Karau, Southlake, TX (US)

(72) Inventor: William H. Karau, Southlake, TX (US)

(21) Appl. No.: 13/479,181

(22) Filed: May 23, 2012

(51) Int. Cl. E02D 29/02; B28B 7/24; E04C 1/39

(52) U.S. Cl. 405/284; 52/503; 249/119

(57) ABSTRACT

A concrete block comprising a front face having a height H1 and a width L1. A lip disposed underneath the front have having a height H2. A rear face having a height H3 and a width L2, wherein the rear face is shorter than the sum of H1 plus H2 by an amount H4, and wherein the sum of H1 plus H2 equals the sum of H3 plus H4. An upper surface forming a channel.

### FIELD OF THE INVENTION

The present invention pertains to the field of construction materials, and more specifically to a retaining wall block.

### BACKGROUND OF THE INVENTION

Retaining wall blocks and methods of manufacturing retaining wall blocks are known in the art. Prior art retaining wall blocks are generally heavy, because of their intended application, and are therefore expensive to manufacture.

### SUMMARY OF THE INVENTION

In accordance with the present invention, a retaining wall block and method of manufacture are provided that result in a retaining wall block that is both lighter and less expensive.

In accordance with an exemplary embodiment of the present invention, a concrete block is provided. The concrete block includes a front face having a height H1 and a width L1. A lip is disposed underneath the front, and the lip has a height H3. A rear face of the concrete block has a height H2 and a width L2, wherein the rear face is shorter than the sum of H1 plus H3 by an amount H4, and wherein the sum of H1 plus H3 equals the sum of H2 plus H4. An upper surface of the concrete block forms a channel, such as a U-shaped channel.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a retaining wall block in accordance with an exemplary embodiment of the present disclosure;

FIG. 2 is a rear view of a retaining wall block in accordance with an exemplary embodiment of the present disclosure;

FIG. 3 is a bottom view of a retaining wall block in accordance with an exemplary embodiment of the present disclosure;

FIG. 4 is a side view of a retaining wall block in accordance with an exemplary embodiment of the present disclosure;

FIG. 5 is a rear view of a retaining wall formed from a plurality of retaining wall blocks in accordance with an exemplary embodiment of the present disclosure;

FIG. 6 is a front view of a straight retaining wall formed from a plurality of retaining wall blocks in accordance with an exemplary embodiment of the present disclosure;

FIG. 7 is a front view of a curved retaining wall formed from a plurality of retaining wall blocks in accordance with an exemplary embodiment of the present disclosure;

FIG. 8 is a diagram of a mold for forming a plurality of retaining wall blocks in accordance with an exemplary embodiment of the present disclosure;

FIGS. 9A through 9D are diagrams of exemplary cross sectional views of retaining wall blocks in retaining walls in accordance with an exemplary embodiment of the present disclosure;

FIG. 10 is a diagram showing cross-sectional views of retaining wall blocks in accordance with an exemplary embodiment of the present invention;

FIG. 11 is a diagram showing retaining wall blocks nested for shipment;

FIG. 12 is a diagram showing a side view of retaining wall blocks nested for shipment; and

FIG. 13 is a diagram showing an overhead view of retaining wall blocks nested for shipment.

### DETAILED DESCRIPTION OF PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

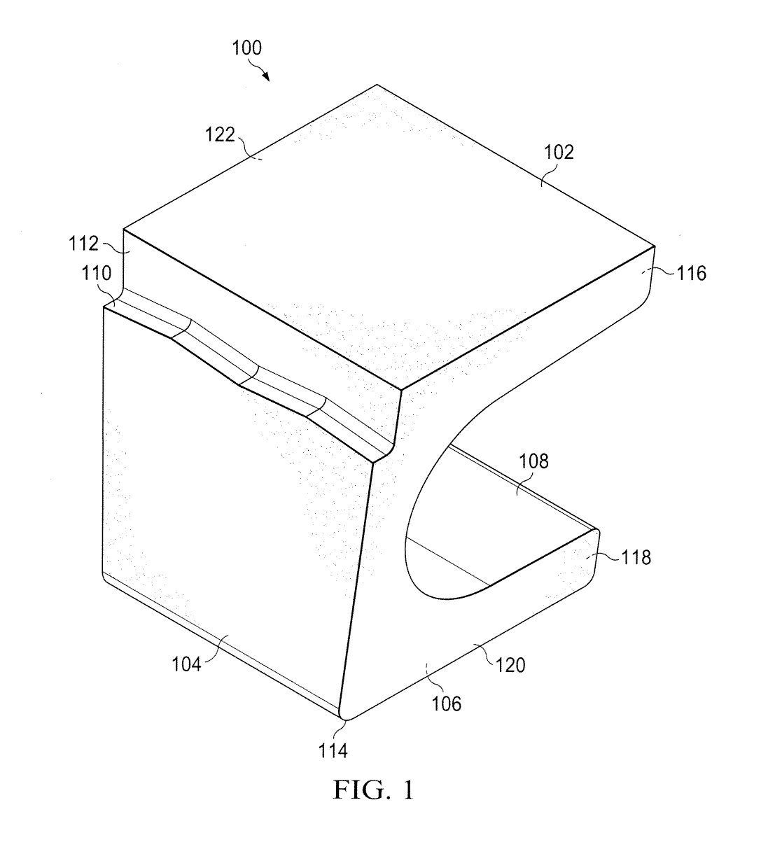

FIG. 1 is a diagram of a retaining wall block 100 in accordance with an exemplary embodiment of the present disclosure. Retaining wall block 100 is a lightweight and low cost retaining wall block, and can be fabricated from concrete or other suitable masonry materials.

Retaining wall block 100 includes front face 102, bottom face 104 and rear face 106. The upper surface 108 of retaining wall block 100 forms a channel that extends through one or more sidewalls and does not form a face, which allows fill material, such as rocks, gravel, or excavated dirt or soil, to be placed within the channel. The channel runs approximately parallel to the front and rear faces, and forms a cross section of the block from the front face to the back face that is approximately constant, as a function of normal manufacturing variations. In this manner, retaining wall block 100 is substantially prismatic along an axis extending approximately parallel to the channel. In this manner, the fill material provides additional mass to a retaining wall formed using plurality of retaining wall blocks 100, which adds stability to the retaining wall that would otherwise be provided by the additional mass of the retaining wall blocks. In addition, the use of fill material to increase the mass of retaining wall block 100 allows retaining wall block 100 to be manufactured at a lower cost from less raw materials while providing the same amount of mass when installed for use in retaining soil, dirt, rocks or other landscaping materials. Each retaining wall block 100 also costs less to ship on a per-unit basis than other retaining wall blocks, because it weighs less than other solid retaining wall blocks. Retaining wall block 100 also provides benefits over hollow retaining wall blocks, which provide the benefit of having a lower per-unit cost to manufacture and a lower shipping weight, but which are not capable of being filled with material during installation and which therefore do not provide a retaining wall with equivalent mass.

Retaining wall block 100 also includes lip 110 and shelf 112, which are configured to interlock with front top surface 116. The dimensions of lip 110 and shelf 112 can be varied as suitable, but in general, the depth of shelf 112 will usually be less than the thickness of the front section of retaining wall block 100, to prevent a retaining wall constructed from a plurality of blocks 100 from leaning forward when it is installed.

Front top surface 116 is shaped so as to fit with the contour of lip 110 of a mating retaining wall block 100, but can have other suitable forms that are easy to manufacture. Lip 110 may include a plurality of angled portions, so as to allow a mating retaining wall block to be placed in a number of different orientations, based on the design of a retaining wall. Likewise, lip 110 can be made straight and without the angled portions where desired. Retaining wall block 100 also includes rear top surface 118, rear bottom corner 114 and sidewalls 120 and 122.

Front face 102 of retaining wall block 100 can also or alternatively be textured. Texture can be applied by using a liner in the section of the mold corresponding to front face 102, where the liner can be attached using multiple links or hinges that allow the liner to rest securely against the sidewall of the mold during molding but to swing downward when the mold is raised, so as to disengage from the side of the retaining wall block.

In use, retaining wall block 100 can be used to build retaining walls that follow existing natural contours. Retaining wall block 100 can be filled with fill material, such as rock, gravel, material from the terrain where the retaining wall is being installed, or other suitable materials that allow retaining wall block 100 to be constructed at a lower cost from less material without a corresponding loss of mass, which is generally required to allow the retaining wall to withstand back pressure from the retained landscaping materials or soil without movement. In addition, the use of local terrain to fill retaining wall block 100 reduces the cost associated with installation, as there will be less displaced earth to be removed. Retaining wall block 100 can also be used with anchors, as further described herein, such as for applications where the back pressure from the retained landscaping materials or material may be high enough to cause the retaining wall to be unstable.

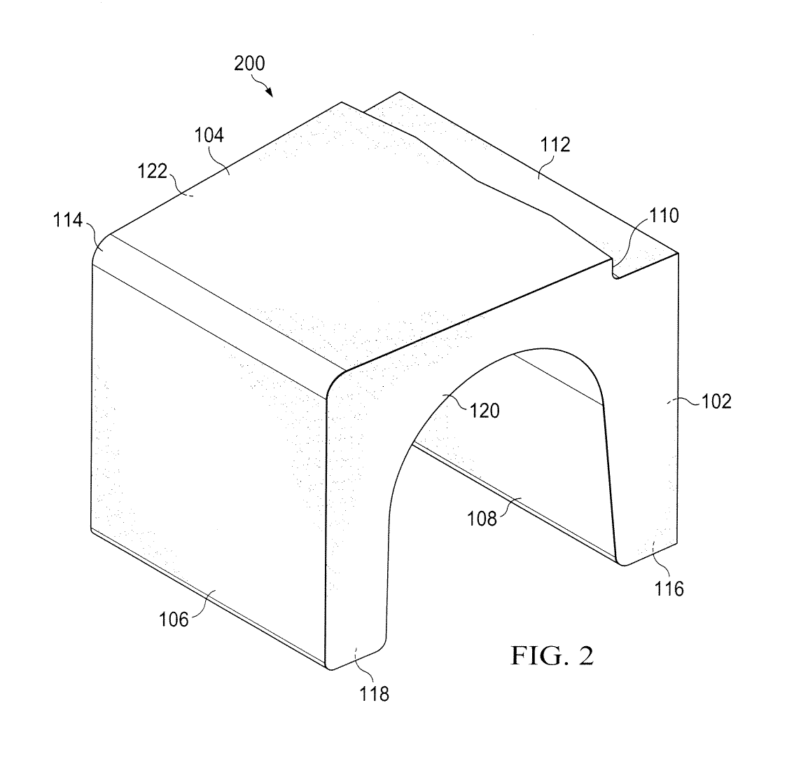

FIG. 2 is a rear view 200 of retaining wall block 100 in accordance with an exemplary embodiment of the present disclosure. Rear view 200 shows the rear face 106, bottom face 104, rear bottom corner 114, shelf 112, part of upper surface 108 and sidewall 120 of retaining wall block 100. The locations of front face 102, rear top surface 118, front top surface 116 and sidewall 122 are also indicated, but they are not shown.

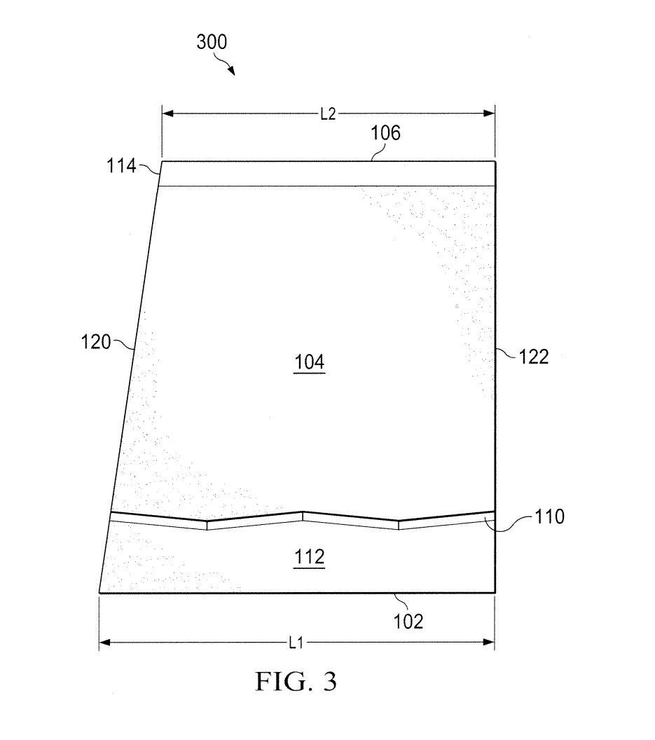

FIG. 3 is a bottom view 300 of retaining wall block 100 in accordance with an exemplary embodiment of the present disclosure. Bottom view 300 shows a width of length L1 of front face 102 and a width of length L2 of rear face 106. Sidewall 120 can be perpendicular to front face 102 and rear face 106, or can be disposed at a suitable angle. Likewise, sidewall 122 can be disposed at an angle to front face 102 and rear face 106, or can be perpendicular when coordinated with an angular disposition for sidewall 120.

When an angular disposition is provided for one or both of sidewalls 120 and 122 such that L2 is less than L1, retaining wall block 100 can be installed so as to follow a curved landscape feature. In addition, anchors can be used in conjunction with retaining wall block 100 when L2 is less than L1, such as by disposing the anchors between the gaps in adjacent blocks. Because retaining wall block 100 is formed on its side, the width of the front and rear faces will need to be controlled using a stripper shoe that is disposed at an angle during the molding process, as described herein.

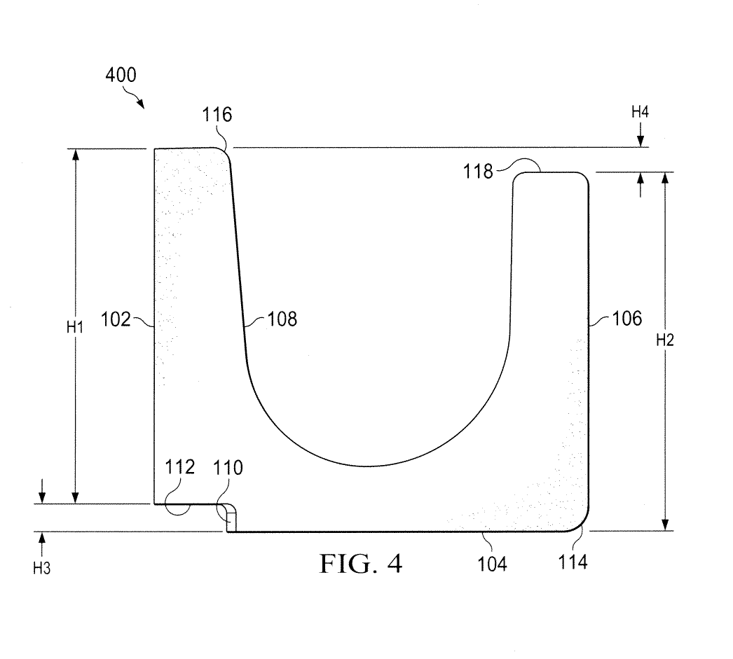

FIG. 4 is a side view 400 of retaining wall block 100 in accordance with an exemplary embodiment of the present disclosure. Side view 400 shows height H1 of front face 102 and height H2 of rear face 106, as well as heights H3 and H4, which represent the differences between the bottom of front face 102 and the bottom surface 104 of retaining wall block 100, and the top of rear face 106 and the top of front face 102, respectively. While each height of height pairs (H1, H2) and (H3, H4) can be equal or different, the sum of H1+H3 should equal the sum of H2+H4, in order to allow a retaining wall to be formed by stacking a plurality of courses of retaining wall blocks 100.

In addition, side view 400 also shows the channel formed by upper surface 108, which can be filled with rock, gravel, excavated materials or other suitable materials to provide additional mass for a retaining wall, and which also allows the amount of excavated material that must be disposed of to be reduced. Anchor structures such as cross-connected rebar or other suitable materials can be disposed in the channel, or geogrid or fabric materials can be lined along upper surface 108 and trailed behind rear face 106, prior to filling the channel with fill material.

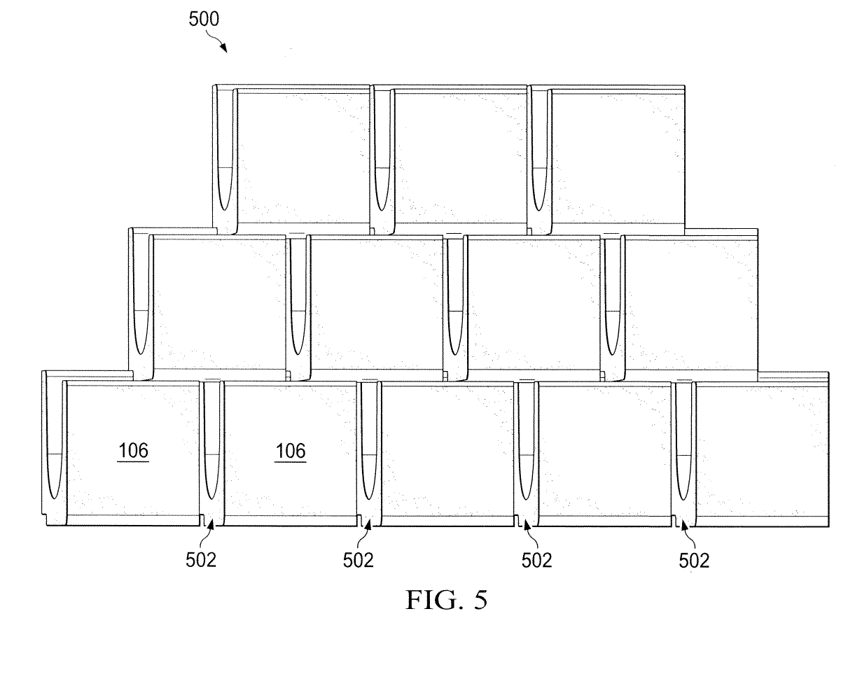

FIG. 5 is a rear view 500 of a retaining wall formed from a plurality of retaining wall blocks 100 in accordance with an exemplary embodiment of the present disclosure. While the front faces 102 of the retaining wall blocks 100 form a continuous surface, the rear faces 106 form a plurality of gaps 502, which allow anchors to be placed within the cavities formed by upper surfaces 108 and to extend through gaps 502 into the soil behind the retaining wall. Fill material can then be placed within the channel and over the anchor. In this manner, no special assembly procedures are required to use anchors with the retaining wall blocks 100, such as the use of special blocks, block caps or equipment.

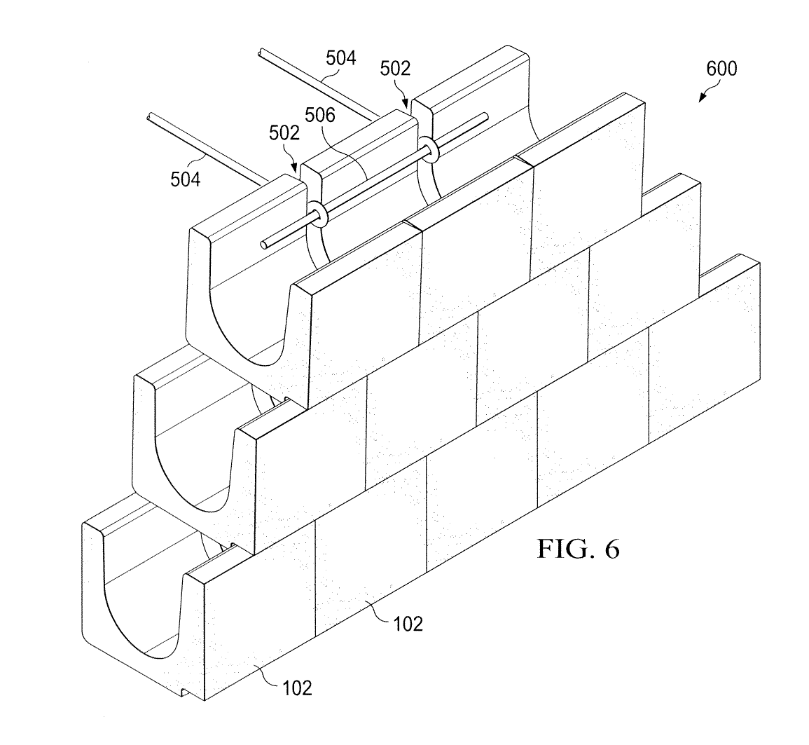

FIG. 6 is a front view 600 of a straight retaining wall formed from a plurality of retaining wall blocks 100 in accordance with an exemplary embodiment of the present disclosure. view 600 shows how the front faces 102 of the retaining wall blocks 100 form a continuous surface. In addition, several of the gaps 502 formed by the rear faces 106 can be seen. The row of cavities formed by a course of blocks can easily be filled by concrete, rebar or other suitable materials to form a bond beam.

Front view 600 also includes an anchor support 506, which is connected to anchors 504 by welding, bolts or in other suitable manners. Anchor support 506 is placed within the cavities formed by upper surfaces 108 of retaining wall blocks 100, and anchors 504 extend through gaps 502 between the retaining wall blocks 100. In one exemplary embodiment, anchor support 506 can be placed within the cavities of a first course of retaining wall blocks 100, and anchors 504 can then be placed in gaps 502 between the retaining wall blocks 100 and attached to anchor support 506 by welding, bolts or in other suitable manners. Fill dirt can then be placed within the cavities, and anchors 504 can be covered with a layer of excavated earth. Anchors 504 and also or alternatively be driven into the earth behind the course of retaining wall blocks 100. After a first course of retaining wall blocks is constructed, a second course can then be constructed on top of the first course. Successive courses can then be installed in the same manner to form a retaining wall.

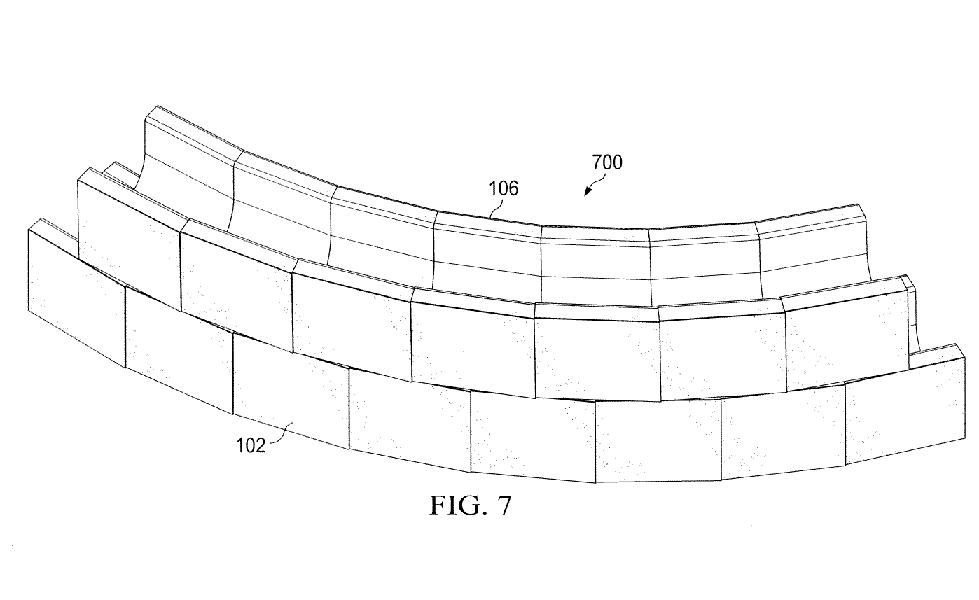

FIG. 7 is a front view 700 of a curved retaining wall formed from a plurality of retaining wall blocks 100 in accordance with an exemplary embodiment of the present disclosure. Front view 700 shows how the front faces 102 of the retaining wall blocks 100 form a continuous surface. In addition, the rear faces 106 also form a continuous surface, in that there are no gaps 502. Front view 700 thus demonstrates one of the advantages of retaining wall block 100, in that the existing landscape contours can be followed using a single block design, which eliminates the need for different block designs.

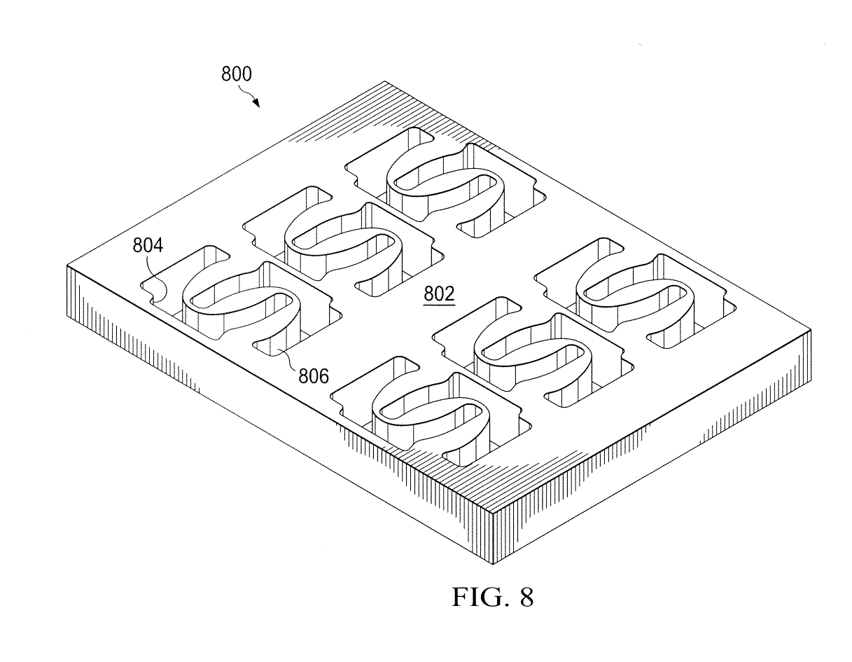

FIG. 8 is a diagram of a mold 800 for forming a plurality of retaining wall blocks 100 in accordance with an exemplary embodiment of the present disclosure. Mold 800 includes a plurality of pairs of mold cavities 804 and 806 that are set in a mold body 802. Each of mold cavities 804 and 806 yields a retaining wall block 100 when used as a mold, and includes a negative corresponding surface for each of front face 102, bottom face 104, rear face 106, upper surface 108, lip 110, shelf 112, rear bottom corner 114, front top surface 116 and rear top surface 118. Sidewalls 120 and 122 are formed by placing mold 800 against a bottom planar surface and by the use of an angled stripper shoe at the top of the mold, respectively.

Mold 800 is configured for use in a dry cast molding process. Dry cast material is placed within mold cavities 804 and 806. The dry cast material is pressed, under vibration, into place by a stripper shoe compression head (not explicitly shown), which is inserted into mold cavities 804 and 806. The stripper shoe compression head can be angled to provide a difference between L1 and L2 as shown in FIG. 3, if such a difference is desired. Mold 800 is then removed while the stripper shoe compression head is held in place, and the individual nested retaining wall blocks 100 are allowed to harden. A plate can be used to seal the open bottom of the mold during this process.

In operation, mold 800 increases the efficiency of the manufacturing process for retaining wall blocks by increasing the number of blocks that can be made in a unit space. Unlike prior art blocks that are not capable of being nested, retaining wall blocks 100 can be nested in mold 800, which results in greater efficiency during the molding process.

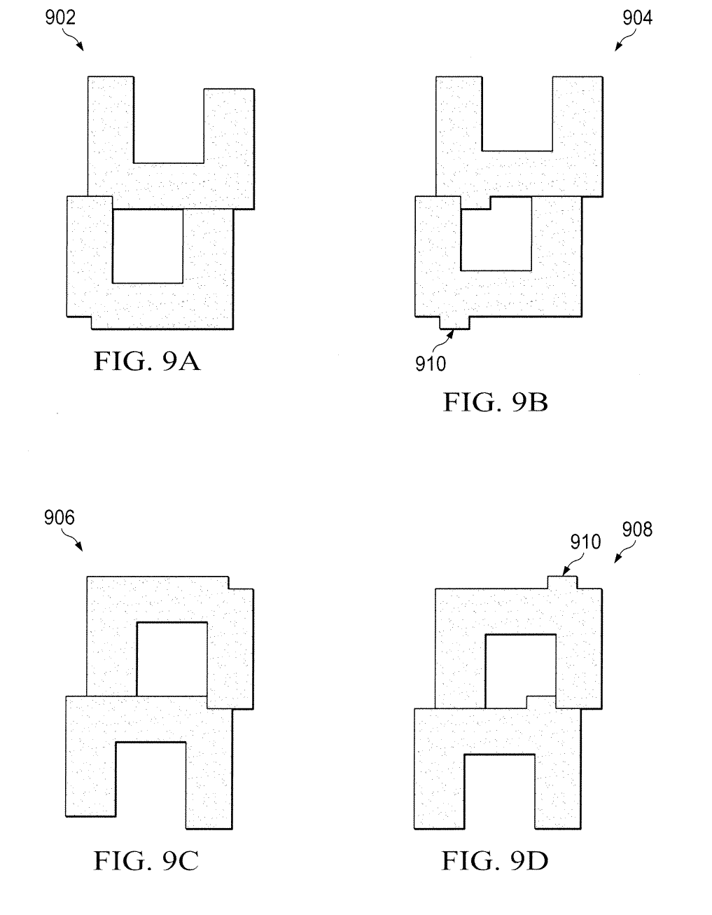

FIGS. 9A through 9D are diagrams 902, 904, 906 and 908 of exemplary cross sectional views of retaining wall blocks in retaining walls in accordance with an exemplary embodiment of the present disclosure. Cross sectional view 902 is a stylized version of retaining wall block 100. Cross sectional view 904 has a front face and a rear face that are of equal height, and includes a lip 910 that abuts the inner surface opposite the front face. Cross sectional views 906 and 908 are essentially the same as cross sectional views 902 and 904, except they are rotated 180 degrees.

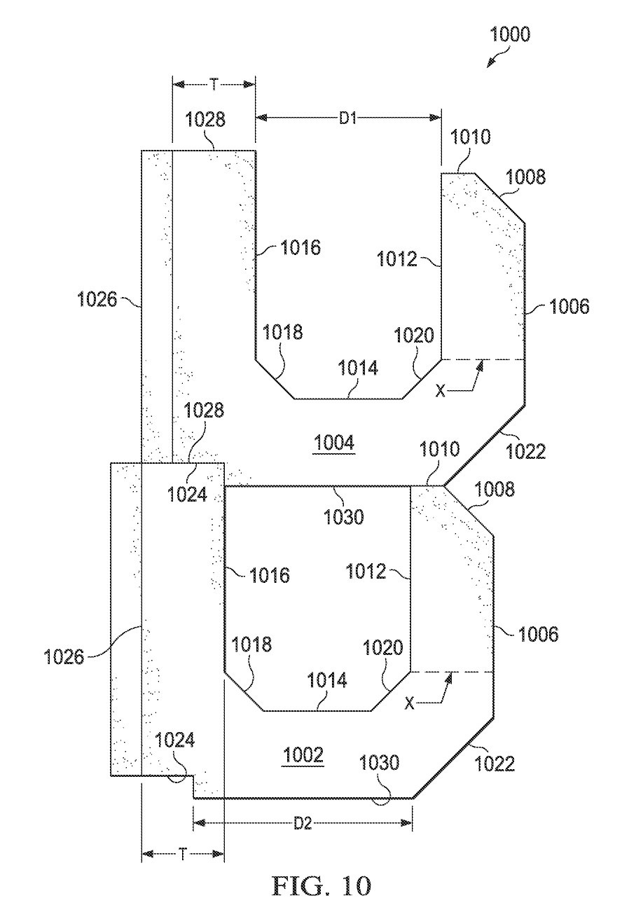

FIG. 10 is a diagram 1000 showing cross-sectional views of retaining wall blocks in accordance with an exemplary embodiment of the present invention. Retaining wall blocks 1002 and 1004 are shown stacked as they might normally be used, and include rear face 1006, top beveled edge 1008, top rear surface 1010, inside rear surface 1012, inside bottom surface 1014, inside front surface 1016, inside front corner 1018, inside rear corner 1020, bottom beveled edge 1022, notch 1024, front face 1026, front top surface 1028 and base 1030. As shown in diagram 1000, notch 1024 mates with front top surface 1028, and base 1030 rests on top rear surface 1010. Top beveled edge 1008 is provided to allow retaining wall block 1002 to be nested with retaining wall block 1004, as discussed below. In this regard, top beveled edge 1008 is configured not to impact with inside front corner 1018. In addition, to allow retaining wall block 1004 to be stacked on top of retaining wall block 1002, dimension D1 (which represents the distance between inside rear surface 1012 and inside front surface 1016) should be less than dimension D2 (which represents the depth of base 1030. The exact dimensions and configuration of top beveled edge 1008, top rear surface 1010, inside front corner 1018, inside rear corner 1020, bottom beveled edge 1022, notch 1024 and base 1030 can be varied to accommodate manufacturing tolerances.

Wall thickness T of retaining wall blocks 1002 and 1004 does not need to be uniform as long as other critical dimensions are maintained, but is generally determined based on the material characteristics of the concrete or other masonry materials that is being used to manufacture the retaining wall blocks. Because retaining wall blocks 1002 and 1004 are used to minimize the amount of concrete or other masonry material that is needed to manufacture the retaining wall blocks, in order to reduce the per-block cost of each retaining wall block and associated shipping weight, the wall thickness will typically be uniform.

Because retaining wall blocks 1002 and 1004 have an opening in the top and inner channel, a cap can also be used to provide an aesthetically-pleasing top surface to a completed retaining wall. In order to provide a “capless” retaining wall block, such that an additional cap block does not need to be manufactured or kept in stock, the rear face can be broken off at break point X to allow fill material to be uniformly provided up to the rear surface of the front wall. In addition, a notch or other feature can be provided at break point X to make it easier to break off the rear face, although such features might also result in greater inadvertent breakage. Based on the material strength of concrete and other masonry materials, another block or other common construction equipment such as a hammer should be sufficient to allow the rear face to be easily broken off by construction personnel without the need for a break point notch.

A mold liner can be utilized to provide an embossed front face 1026, where suitable. Such mold liners are typically attached to one side of the mold by hinges or links, and swing away from the molded block when the mold is lifted off the block.

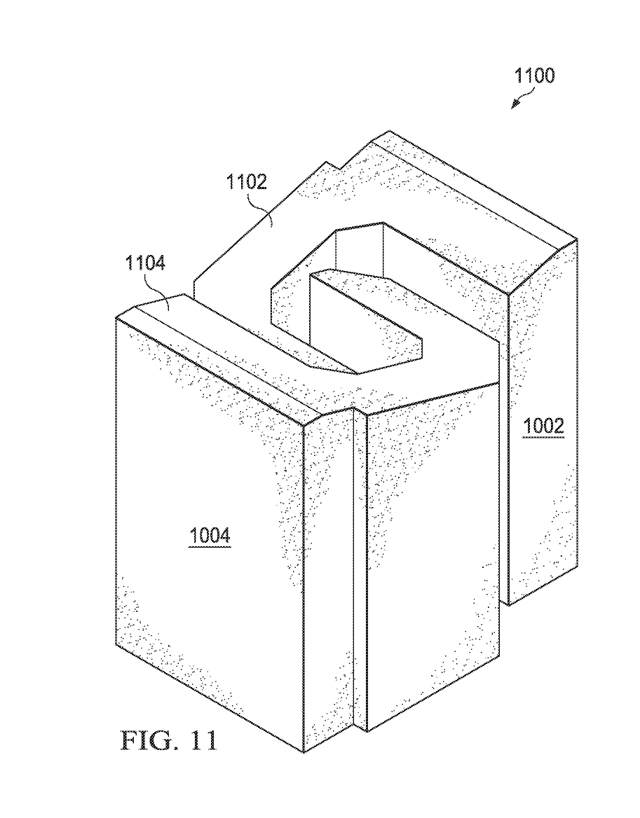

FIG. 11 is a diagram 1100 showing retaining wall blocks 1002 and 1004 nested for shipment. As shown in diagram 1100, the rear faces of each of retaining wall blocks 1002 and 1004 are placed with the inner channel of the other block, such that the angled side faces 1102 1104 of retaining wall blocks 1002 and 1004, respectively, are disposed on one side and the perpendicular side faces of retaining wall blocks 1002 and 1004 are disposed on the opposite side.

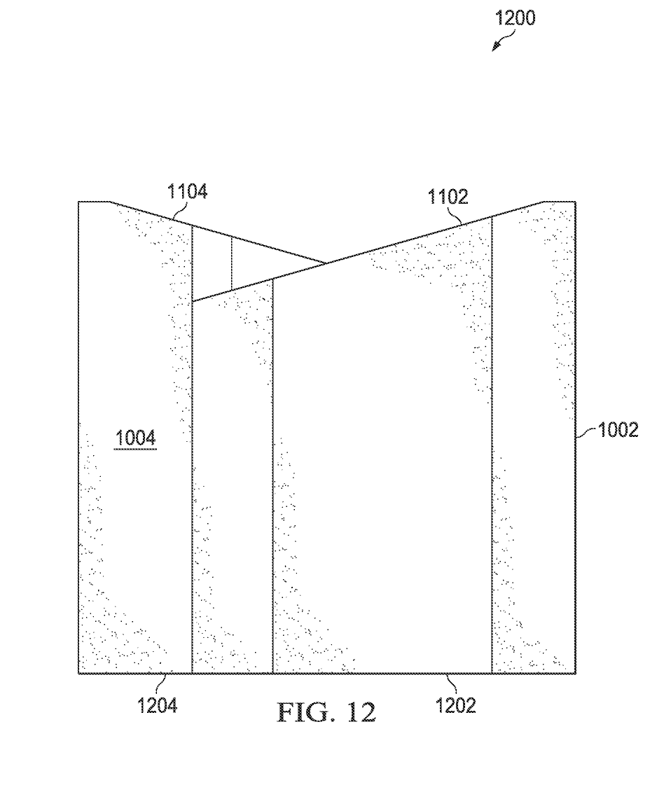

FIG. 12 is a diagram 1200 showing a side view of retaining wall blocks 1002 and 1004 nested for shipment. As shown in diagram 1200, the rear face of retaining wall block 1002 can abut the inside front surface of retaining wall block 1004, and the base of retaining wall block 1002 covers the channel of retaining wall block 1004. The angled side faces 1102 and 1104 of retaining wall blocks 1002 and 1004, respectively, are disposed on one side and the perpendicular side faces 1202 and 1204 of retaining wall blocks 1002 and 1004, respectively, are disposed on the opposite side.

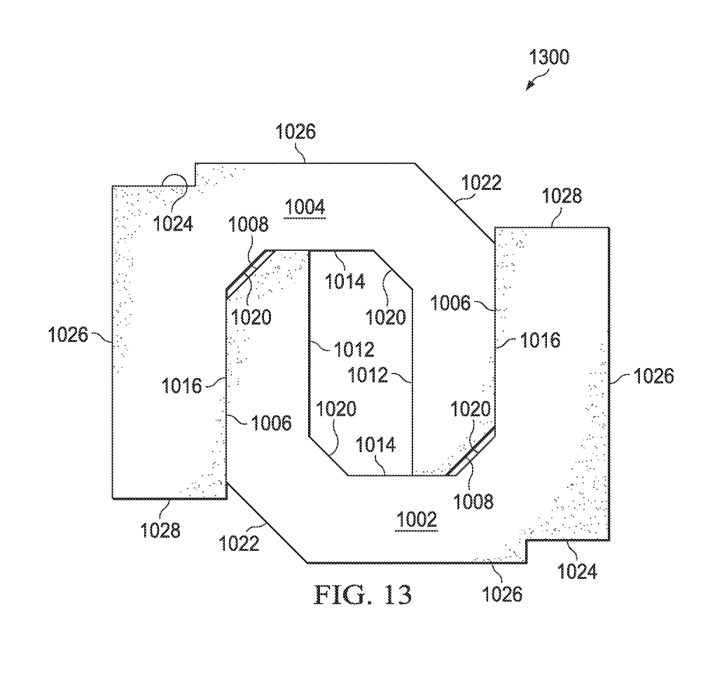

FIG. 13 is a diagram 1300 showing an overhead view of retaining wall blocks 1002 and 1004 nested for shipment. As shown in diagram 1300, the rear face 1006 of each retaining wall block abuts the inside front surface 1016 of the other retaining wall block, and top beveled edge 1008 of each retaining wall block does not interfere with the inside rear corner 1020 of the other retaining wall block. In this manner, the retaining wall blocks can be securely nested for shipment to reduce the amount of pallet space required.

Although exemplary embodiments of a system and method of the present invention have been described in detail herein, those skilled in the art will also recognize that various substitutions and modifications can be made to the systems and methods without departing from the scope and spirit of the appended claims.

1. A concrete block comprising:
a front face having a height H1 and a width L1;
a lip disposed underneath the front face having a height H3;
a rear face having a height H2 and a width L2, wherein the rear face is shorter than the sum of H1 plus H3 by an amount H4, and L1 is greater than L2; and
an upper surface forming a channel extending through at least one sidewall.

2. The concrete block of claim 1 wherein the concrete block has a cross section that is approximately constant.

3. The concrete block of claim 1 wherein H1 is equal to H2, and further comprising a flat bottom surface.

4. The concrete block of claim 1 wherein the lip extends the width L1.

5. The concrete block of claim 1 wherein the upper surface forms a U-shaped channel.

6. The concrete block of claim 1 further comprising a shelf extending approximately perpendicular from the front face towards the rear face and intersecting with the lip.

7. The concrete block of claim 5 wherein the U-shaped channel surface is substantially prismatic.

8. The concrete block of claim 1 wherein the the rear face does not have a lip.

9. The concrete block of claim 1 wherein the block is substantially prismatic along an axis.

10. The concrete block of claim 1 wherein the block is substantially prismatic along an axis extending approximately parallel to the channel.

11. The concrete block of claim 1 wherein the upper surface forms the channel extending through at least two sidewalls.

12. The concrete block of claim 1 further comprising a sidewall that is substantially perpendicular to the front face.

13. The concrete block of claim 1 wherein the lip comprises a depth of D1, and where D1 is less than or equal to a thickness of a front wall.

14. A retaining wall comprising:
a first non-linear course of a plurality of blocks, each block having a front face and a rear face, wherein the front faces form a continuous surface, and a plurality of gaps are formed between the rear faces of each of the blocks;
a second non-linear course of a plurality of blocks on top of the first course of blocks;
a channel extending through the first course; and
wherein a lip extends below the front face of each of the blocks in the second course of blocks, and the lip abuts a front top surface of two or more of the blocks in the first course of blocks.

15. The retaining wall of claim 14 further comprising an anchor support disposed in the channel of the first course of the plurality of blocks.

16. The retaining wall of claim 14 further comprising an anchor disposed in the channel of the first course of the plurality of blocks.

17. The retaining wall block of claim 14 further comprising an anchor disposed in one of the plurality of gaps.

18. A mold comprising:
one or more cavities, each comprising:
a front face having a height H1 and a width L1;
a lip disposed underneath the front face having a height H2;
a rear face having a height H3 and a width L2, wherein the rear face is shorter than the sum of H1 plus H2 by an amount H4, and wherein the sum of H1 plus H2 equals the sum of H3 plus H4;
an upper surface forming a channel through at least one sidewall in a concrete block formed by the mold; and
wherein a stripper shoe compression head is configured to be placed in each of the cavities to provide the width L1 for the front face and the width L2 for the rear face, and L1 is not equal to L2.

19. The mold of claim 18 wherein L1 is greater than L2 and wherein the mold provides a bottom surface that is flat between a bottom of the lip and a bottom of the rear face.

20. The mold of claim 18 wherein H1 is equal to H2.

21. The mold of claim 18 wherein the lip comprises a plurality of angled portions and extends the width L1.

22. The mold of claim 18 wherein the upper surface forms a U-shaped channel.

23. The mold of claim 18 further comprising a shelf extending approximately perpendicular from the front face towards to the rear face and intersecting with the lip.
